(19) United States
(12) Patent Application Publication
(10) Pub. No.: US 2011/0013862 A1
(43) Pub. Date: Jan. 20, 2011

(54) BEARING STRUCTURE FOR CRANKSHAFT

(75) Inventor: Kenji Nakamure, Aichi-ken (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/449,391

(22) PCT Filed: Mar. 6, 2008
(86) PCT No.: PCT/JP2008/054007

§ 371 Date: Aug. 6, 2009

(30) Foreign Application Priority Data
Mar. 6, 2007 (JP) 2007-055397

(51) Int. Cl. F16C 9/00; F16C 9/02

(52) U.S. Cl. 384/457; 123/195 H

(57) ABSTRACT

A bearing structure of a crankshaft is disclosed. The crankshaft is rotatably held by a lower cylinder block portion and a bearing cap arranged below the lower cylinder block portion. Stress relaxation grooves extending along the axis of the crankshaft are formed in upper portions of opposite sides of the bearing cap. The stress relaxation grooves have openings in opposite side surfaces of the bearing cap. By forming the stress relaxation grooves, projecting ends extending along the axis of the crankshaft are formed in the upper portions at the opposite sides of the bearing cap. The projecting ends are flexible in response to load acting on the bearing cap when the crankshaft rotates.

### TECHNICAL FIELD

The present invention relates to a bearing structure for a crankshaft, and, more particularly, a crankshaft bearing structure rotatably holding a crankshaft by a lower cylinder block portion and a bearing cap arranged below the lower cylinder block portion.

### BACKGROUND ART

A typical crankshaft bearing structure rotatably holds a crankshaft between a metal bearing portion received in a semicircular recess formed in a cylinder block and another metal bearing portion accommodated in a semicircular recess formed in a bearing cap. The bearing cap is fastened to the cylinder block through bolts at opposite sides of the recess of the bearing cap by a predetermined fastening torque. The crankshaft smoothly rotates about its axis while held by the metal bearing portions.

Patent Document 1 discloses a bearing structure holding a plurality of shaft portions of a crankshaft, which are formed by a number corresponding to the number of the cylinders of the engine. The bearing structure holds shaft portions through a bearing cap and a bearing of a cylinder block, in such a manner that the shaft portions rotate smoothly.

As shown in FIG. 8(b), the conventional bearing structure includes a lower cylinder block portion 51, a bearing cap 52, an upper metal bearing portion 53, a lower metal bearing portion 54, bolts 56, 57, and positioning pins 58, 59 serving as joint members. The bearing structure of the crankshaft includes engagement holes formed in opposing engagement surfaces of the bearing cap 52 and the lower cylinder block portion 51. By pressing the positioning pins 58, 59 into the engagement holes, the bearing cap 52 and the lower cylinder block portion 51 are joined together.

However, the bearing cap 52 is fastened to the lower cylinder block portion 51 through the bolts 56, 57 by a predetermined fastening torque (Nm). The lower surface of the lower cylinder block portion 51 receives stress (MPa) from the bearing cap 52. The stress (MPa) acts as compressive stress (MPa) at portions of the lower surface of the lower cylinder block portion 51 other than the portions corresponding to side surfaces 52a, 52b of the bearing cap 52 (the portions indicated by arrows A and B). However, the stress (MPa) acts as shearing stress (MPa) at the portions indicated by arrows A and B.

When the crankshaft 55 rotates in this state, inertia force C having explosion load correspondingly acts in a radial direction of the crankshaft 55. Particularly, the inertia force C acting downwardly with respect to the bearing cap 52 slightly flexes the bearing cap 52 downward. This applies stress in a concentrated manner to the portions of the lower surface of the lower cylinder block portion 51 indicated by arrows A and B, as illustrated in FIG. 8(a).

After the lower cylinder block portion 51 and the bearing cap 52 repeatedly receive the inertia force C, the lower surface of the lower cylinder block portion 51 separates from the top surface of the bearing cap 52. As a result, cracks may occur in the portions of the lower surface of the lower cylinder block portion 51 indicated by arrows A and B due to fretting fatigue.

To prevent the formation of such cracks, concentrated stress may be reduced by forming an arcuate groove in each of the portions of the lower surface of the lower cylinder block portion 51 indicated by arrows A and B. However, the arcuate grooves decrease the holding force of the lower cylinder block portion 51 and the bearing cap 52 to hold the crankshaft 55.

Also, when arcuate grooves are provided in the portions of the lower surface of the lower cylinder block portion 51 indicated by arrows A and B, the bearing cap 52 must be enlarged in order to ensure a sufficient contact area between the lower cylinder block portion 51 and the bearing cap 52. This disadvantageously increases the weight of the bearing structure and the space occupied by the bearing structure. Patent Document 1: Japanese Laid-Open Patent Publication No. 2005-195114

### SUMMARY OF THE INVENTION

Accordingly, it is an objective of the present invention to provide a highly durable crankshaft bearing structure that prevents cracks from forming in a lower cylinder block portion due to fretting fatigue while ensuring a sufficient contact area between the lower cylinder block portion and a bearing cap.

To achieve the foregoing objective and in accordance with a first aspect of the present invention, a bearing structure for a crankshaft is provided. The crankshaft is rotatably held by a lower cylinder block portion and a bearing cap arranged below the lower cylinder block portion. Stress relaxation grooves extending along the axis of the crankshaft are formed in upper portions of opposite sides of the bearing cap. The stress relaxation grooves have openings in opposite side surfaces of the bearing cap. By forming the stress relaxation grooves, projecting ends extending along the axis of the crankshaft are formed in the upper portions at the opposite sides of the bearing cap. The projecting ends are flexible in response to a load acting on the bearing cap when the crankshaft rotates.

In accordance with a second aspect of the present invention, a bearing structure for a crankshaft is provided. The crankshaft being rotatably is held by a lower cylinder block portion and a bearing cap arranged below the lower cylinder block portion. Projections extending along the axis of the crankshaft are formed in upper portions of opposite sides of the bearing cap. The projections project from opposite side surfaces of the bearing cap in directions away from the crankshaft and having a top surface contacting the lower cylinder block portion.

### BRIEF DESCRIPTION OF THE DRAWINGS

FIG. 1 is a partially exploded perspective view showing a crankshaft bearing structure according to a first embodiment of the present invention;

FIG. 2 is a perspective view showing a bearing cap of the crankshaft bearing structure illustrated in FIG. 1;

FIG. 3(a) is a cross-sectional view taken along line 3-3 of FIG. 2;

FIG. 3(b) is an enlarged cross-sectional view showing portion 3b of FIG. 3(a);

FIG. 4(a) is a diagram in reference to which stress acting on a bearing cap attachment portion of the crankshaft bearing structure illustrated in FIG. 1 is explained;

FIG. 4(b) is a cross-sectional view showing the crankshaft bearing structure corresponding to FIG. 4(a);

FIG. 5(a) is a cross-sectional view showing a portion of a bearing cap of a crankshaft bearing structure according to a second embodiment;

FIG. 5(b) is an enlarged cross-sectional view showing portion 5b illustrated in FIG. 5(a);

FIG. 6(a) is a cross-sectional view showing a portion of a bearing cap of a crankshaft bearing structure according to a third embodiment;

FIG. 6(b) is an enlarged cross-sectional view showing portion 6b illustrated in FIG. 6(a);

FIG. 7(a) is a cross-sectional view showing a portion of a bearing cap of a crankshaft bearing structure according to a fourth embodiment;

FIG. 7(b) is an enlarged cross-sectional view showing portion 7b illustrated in FIG. 7(a);

FIG. 8(a) is a diagram in reference to which stress acting on a bearing cap attachment portion of a conventional crankshaft bearing structure is explained; and

FIG. 8(b) is a cross-sectional view showing the crankshaft bearing structure corresponding to FIG. 8(a).

### BEST MODE FOR CARRYING OUT THE INVENTION

A bearing structure 1 of a crankshaft 6 according to a first embodiment of the present invention will now be described with reference to the attached drawings.

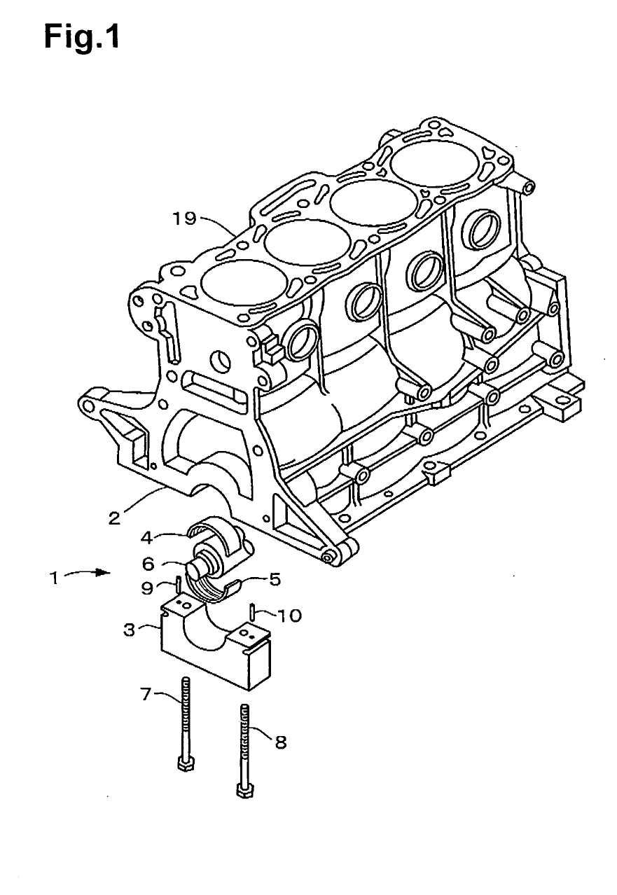

FIGS. 1 to 4 illustrate the bearing structure 1 of the crankshaft 6.

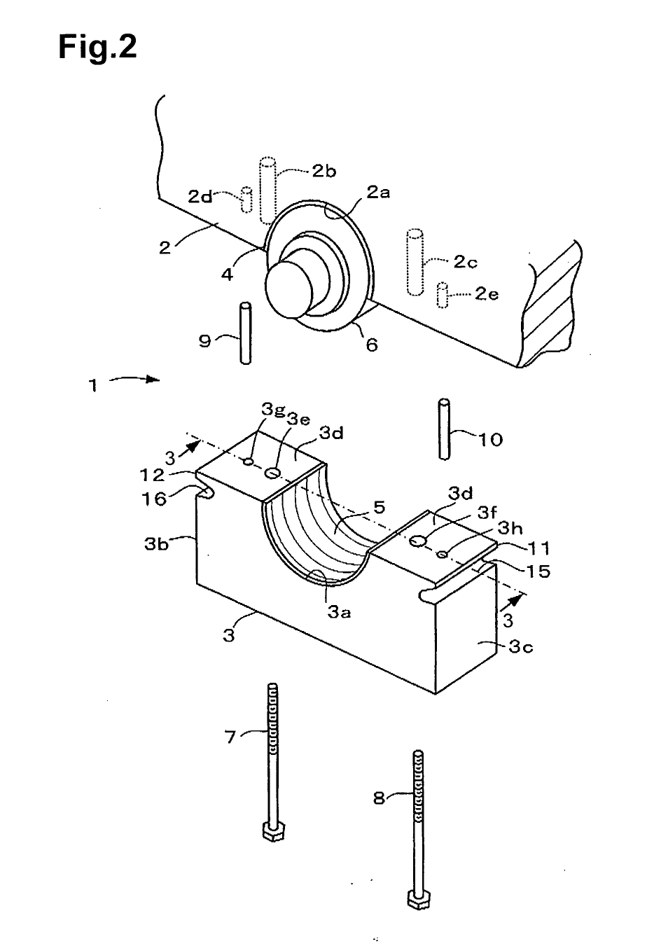

As illustrated in FIGS. 1 and 2, the bearing structure 1 includes a lower cylinder block portion 2, a bearing cap 3, an upper metal bearing portion 4, a lower metal bearing portion 5, the crankshaft 6, bolts 7, 8, and positioning pins 9, 10. A plurality of shaft portions are formed in the crankshaft 6 in correspondence with a plurality of cylinders of the engine. Each shaft portion is supported by a corresponding bearing structure 1, which is illustrated in FIG. 2. Specifically, the bearing structure 1 illustrated in FIG. 2 is one of the multiple bearing structures 1. The single bearing structure will be explained below.

The lower cylinder block portion 2 has a semicircular recess 2a facing downward, which is formed in a central portion of the lower cylinder block portion 2 in a direction perpendicular to the direction in which the cylinders are arranged in a cylinder block 19. The recess 2a receives the upper metal bearing portion 4. The lower cylinder block portion 2 includes threaded bolt holes 2b, 2c and threaded pin holes 2d, 2e, which are arranged at opposite sides of the recess 2a. The bolts 7, 8 are threaded to the corresponding threaded bolt holes 2b, 2c and the positioning pins 9, 10 are passed through the corresponding pin holes 2d, 2e. The cylinder block 19 is a known type made of light aluminum alloy or the like and has cylinder holes accommodating pistons and a water jacket in which coolant water flows. Although the cylinder block 19 is illustrated as a cylinder block for an in-line four-cylinder engine in FIG. 1, the cylinder block 19 may include a single cylinder or multiple cylinders by a number other than four. Further, the cylinder block 19 may be a different type of engine such as a V type.

The bearing cap 3 is made of iron material such as cast iron (FC) and is an independently structured rectangular block. With reference to FIG. 2, a recess 3a, which receives the lower metal bearing portion 5, is formed in an upper portion of the bearing cap 3. The bearing cap 3 has bolt through holes 3e, 3f and pin holes 3g, 3h, which are formed at opposite sides of the recess 3a. The bolt through hole 3e and the bolt through hole 3f are arranged at the positions corresponding to the threaded bolt hole 2b and the threaded bolt hole 2c of the lower cylinder block portion 2, respectively. The pin hole 3g and the pin hole 3h are arranged at the positions opposed to the pin hole 2d and the pin hole 2e of the lower cylinder block portion 2, respectively.

A stress relaxation groove 15, which has an opening in a side surface 3c of the bearing cap 3 and extends along the axis of the crankshaft 6, is formed in an upper portion of the side surface 3c. The portion of the bearing cap 3 above the stress relaxation groove 15 forms a projecting end 11, which contacts the lower cylinder block portion 2. The projecting end 11 extends in the axial direction of the crankshaft 6. A stress relaxation groove 16 like the stress relaxation groove 15 is formed in an upper portion of a side surface 3b of the bearing cap 3 opposite to the side surface 3c. The portion of the bearing cap 3 above the stress relaxation groove 16 forms a projecting end 12, which contacts the lower cylinder block portion 2. The projecting end 12 extends in the axial direction of the crankshaft 6.

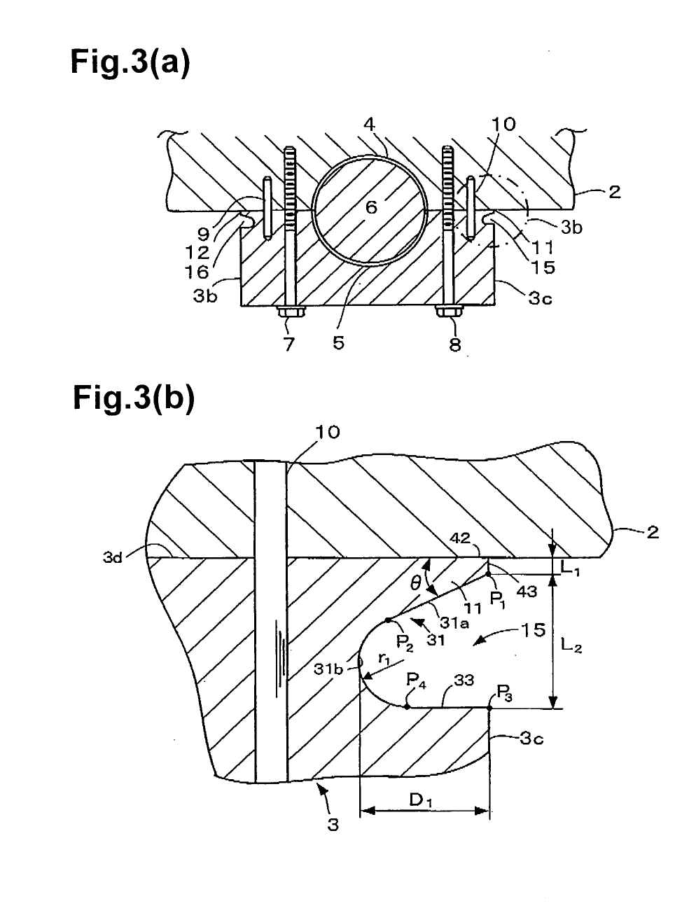

As illustrated in FIGS. 3(a) and 3(b), a cross section of the stress relaxation groove 15 along a plane perpendicular to the axis of the crankshaft 6 is formed by a line connecting point P1 and point P2, a line connecting point P3 and point P4, and a curve connecting point P2 and point P4. Point P1 is spaced from a top surface 3d of the bearing cap 3 along the side surface 3c of the bearing cap 3 by a distance L1. Point P2 is spaced from point P1 in an inward direction of the stress relaxation groove 15. Point P3 is spaced downward from point P1 along the side surface 3c by a distance L2. Point P4 is spaced from point P3 in the inward direction of the stress relaxation groove 15. The curve connecting points P2 and P4 has a radius of curvature r1. The radius of curvature refers to the radius of a circle that approximates a local curvature of a curve.

The line connecting points P1 and P2 is inclined with respect to the top surface 3d by the angle θ. The angle θ varies depending on the type of the vehicle, engine performance, the materials of the cylinder block 19 and the bearing cap 3, and other conditions. The angle θ may be set to any suitable value as long as the angle θ decreases the rigidity of the projecting end 11 above the stress relaxation groove 15 and provides flexibility to the projecting end 11. In other words, the angle θ may be set to any suitable value as long as the shearing stress produced in the lower cylinder block portion 2 is reduced.

Like the angle θ, the distance L1 varies depending on the type of the vehicle, engine performance, the materials of the cylinder block 19 and the bearing cap 3, the angle θ, and other conditions. The distance L1 may be set to any suitable value as long as the distance L1 decreases the rigidity of the projecting end 11 and provides flexibility to the projecting end 11. The line connecting points P3 and P4 may be parallel with the top surface 3d or inclined in such a manner that point P3 is located above or below point P4. The line connecting points P1 and P2 is connected to the curve connecting points P2, P4 smoothly at point P2. The curve connecting points P2 and P4 is connected to the line connecting points P3 and P4 smoothly at point P4.

The stress relaxation groove 15 has a depth D1 with respect to the side surface 3c. Like the angle θ and the distance L1, the depth D1 varies depending on the type of the vehicle, engine performance, the materials of the cylinder block 19 and the bearing cap 3, the angle θ, the distance L1, and other conditions. The depth D1 may be set to any suitable value as long as the depth D1 decreases the rigidity of the projecting end 11 and provides flexibility to the projecting end 11. Further, although the bottom of the stress relaxation groove 15 extends parallel with the axis of the crankshaft 6, the bottom of the stress relaxation groove 15 may be inclined upward or downward with respect to the axis of the crankshaft 6 at a predetermined angle. Also, although it is preferable that the depth D1 be uniform in the longitudinal direction of the stress relaxation groove 15, the depth D1 may be varied along the longitudinal directions.

The stress relaxation groove 16 may be located at the position corresponding to the position of the aforementioned stress relaxation groove 15 or a position other than this position and shaped and sized either identically with or different from the stress relaxation groove 15. For example, the stress relaxation groove 16 may be located at a position other than the position corresponding to the stress relaxation groove 15 and shaped and sized differently from the stress relaxation groove 15 in correspondence with the rotational direction or the shape of the crankshaft 8. A plurality of bearing caps 3 are provided in correspondence with a plurality of shaft portions formed in the crankshaft 6. The stress relaxation grooves 15, 16 are formed in each of the bearing caps 3. The positions, the shapes, and the sizes of the stress relaxation grooves 15, 16 may be different from one bearing cap 3 to another or the same for all of the bearing caps 3.

By appropriately selecting the positions, the shapes, and the sizes of the stress relaxation grooves 15, 16 in the above-described manner, the crankshaft 6 is supported by the lower cylinder block portion 2 and the bearing cap 3 through the lower metal bearing portion 5 in a laterally equilibrated manner. This reduces the shearing stress produced in the lower cylinder block portion 3.

As illustrated in FIG. 3(b), the projecting end 11 extends along the axis of the crankshaft 6. Specifically, the projecting end 11 has a top surface 42 contacting the lower cylinder block portion 2, a side surface 43 having a predetermined length L1 as measured downward from the top surface 42, and a lower surface 31 forming the stress relaxation groove 15. The lower surface 31 has an inclined surface 31a inclined with respect to the top surface 42 at the aforementioned angle θ and an arcuate surface 31b formed continuously from the inclined surface 31a and having the radius of curvature r1. The inclined surface 31a is inclined with respect to the top surface 42 in such a manner that the thickness of the projecting end 11 increases from the distal end of the projecting end 11 toward the proximal end. When the inertia force produced by rotation of the crankshaft 8 acts downward with respect to the bearing cap 3, shearing stress is applied to the lower cylinder block portion 2 by the upper portions of the side surfaces 3b, 3c of the bearing cap 3 that press the lower cylinder block portion 2. However, the projecting end 11, which is configured in the above-described manner, deforms toward the stress relaxation groove 15 in such a manner as to relax the shearing stress.

The projecting end 12 may be located at the position corresponding to the position of the aforementioned projecting end 11 or a position other than this position and shaped and sized identically with or differently from the projecting end 11. For example, the projecting end 12 may be located at a position different from the position corresponding to the position of the projecting end 11 and shaped and sized differently from the projecting end 11 in correspondence with the rotational direction or the shape of the crankshaft 6. The bearing caps 3 are formed in correspondence with a plurality of shaft portions formed in the crankshaft 6. The projecting ends 11, 12 are provided in each of the bearing caps 3. The projecting ends 11, 12 may be located, shaped, and sized differently from one bearing cap 3 to another or the same for all of the bearing caps 3. By appropriately selecting the positions, the shapes, and the sizes of the projecting ends 11, 12 as in the above-described case of the stress relaxation grooves 15, 16, the crankshaft 6 is supported by the lower cylinder block portion 2 and the bearing cap 3 through the lower metal bearing portion 5 in a laterally equilibrated manner. As a result, the shearing force produced in the lower cylinder block portion 2 is decreased.

The upper metal bearing portion 4 and the lower metal bearing portion 5 are each formed by, for example, shaping a plate made of metal such as iron steel in an arcuate manner. To improve initial conformability, fine streaks or lubrication grooves are formed in the inner wall surfaces of the upper metal bearing portion 4 and the lower metal bearing portion 5.

The crankshaft 6 is a publicly known type, has crank pins provided by the number corresponding to the number of engine cylinders, and is connected to pistons through connecting rods and rotated through reciprocation of the pistons.

The positioning pins 9, 10 are, for example, columnar pins made of iron steel. One end of each of the positioning pins 9, 10 is pressed into the corresponding one of the pin holes 2d, 2e, which are formed in the lower cylinder block portion 2. The other end of each positioning pin 9, 10 is pressed into the corresponding pin hole 3g, 3h formed in the bearing cap 3. By pressing both ends of each positioning pin 9, 10 into the corresponding holes, the bearing cap 3 is positioned in the lower cylinder block portion 2.

In the bearing structure 1 configured in the above-described manner, one end of each positioning pin 9, 10 is pressed into the corresponding pin hole 2d, 2e of the lower cylinder block portion 2, as shown in FIGS. 2, 3(a), and 3(b). Subsequently, the upper metal bearing portion 4 is received in the recess 2a of the lower cylinder block portion 2. The corresponding shaft portion of the crankshaft 6 is then accommodated in the upper metal bearing portion 4. Next, the lower metal bearing portion 5 is received in the recess 3a of the bearing cap 3 and the other end of each positioning pin 9, 10 is pressed into the corresponding pin hole 3g, 3h of the bearing cap 3 until the top surface 3d of the bearing cap 3 contacts the lower cylinder block portion 2. This positions the bearing cap 3 with respect to the lower cylinder block portion 2.

The bolts 7, 8 are then threaded to the corresponding threaded bolt holes 2b, 2c of the lower cylinder block portion 2 via the associated bolt through holes 3e, 3f. The bearing cap 3 is then fastened to the lower cylinder block portion 2 by a predetermined fastening torque (Nm). This allows the crankshaft 6 to smoothly rotate in a state maintained by the upper metal bearing portion 4 and the lower metal bearing portion 5.

As has been described, by forming the stress relaxation grooves 15, 16 in the upper portions of the corresponding side surfaces 3b, 3c of the bearing cap 3, the projecting ends 11, 12, which contact the lower cylinder block portion 2, are provided in the bearing cap 3. This reduces the shearing stress produced in the lower cylinder block portion 2 while ensuring a sufficient contact surface area between the lower cylinder block portion 2 and the bearing cap 3.

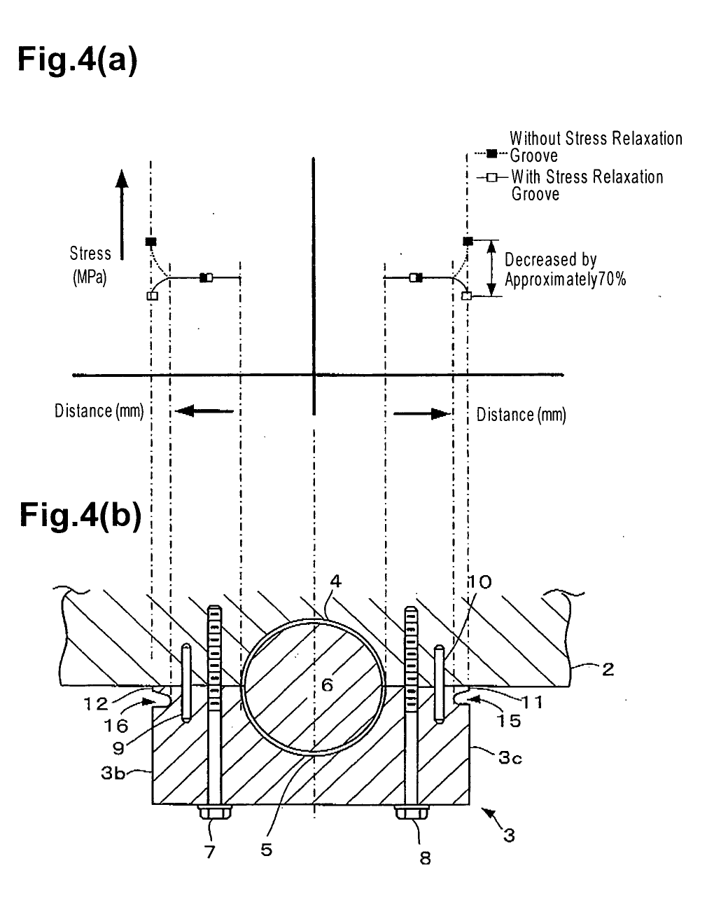

Specifically, as illustrated in FIGS. 4(a) and 4(b), the shearing stress (MPa) produced in each of the portions of the lower cylinder block portion 2 corresponding to the side surfaces 3b, 3c of the bearing cap 3 is significantly decreased. In FIG. 4(a), the broken lines represent the shearing force produced in a conventional bearing structure, and the solid lines represent the shearing force produced in the bearing structure 1 according to the present invention. With reference to FIG. 4(a), the shearing stress produced in each of the portions of the lower cylinder block portion 2 contacting the projecting ends 11, 12 of the bearing cap 3 is reduced by approximately 70% compared to the conventional case. The graph of FIG. 4(a) represents a simulation result obtained through CAE (Computer Aided Engineering). The graph is obtained through simulation under optimal conditions selected using the angle θ, the distance L1, and the depth D1, which are represented in FIG. 3, as parameters. The graph represents the compressive stress (MPa) and the shearing stress (MPa) in the lower cylinder block portion 2. In other words, the shearing stress is produced in the portions of the lower cylinder block portion 2 corresponding to the side surfaces 3b, 3c of the bearing cap 3, and the compressive stress is generated in the portions other than these portions.

When the shearing stress is reduced in this manner, the lower surface of the lower cylinder block portion 2 and the top surface 3d of the bearing cap 3 are prevented from separating from each other even if inertial force in the radial direction of the crankshaft 6 is repeatedly applied through rotation of the crankshaft. Further, cracks due to fretting fatigue do not from. Accordingly, a bearing structure with improved durability is provided.

A bearing structure 1 according to a second embodiment of the present invention will hereafter be described with reference to the attached drawings mainly on the differences between the second embodiment and the first embodiment.

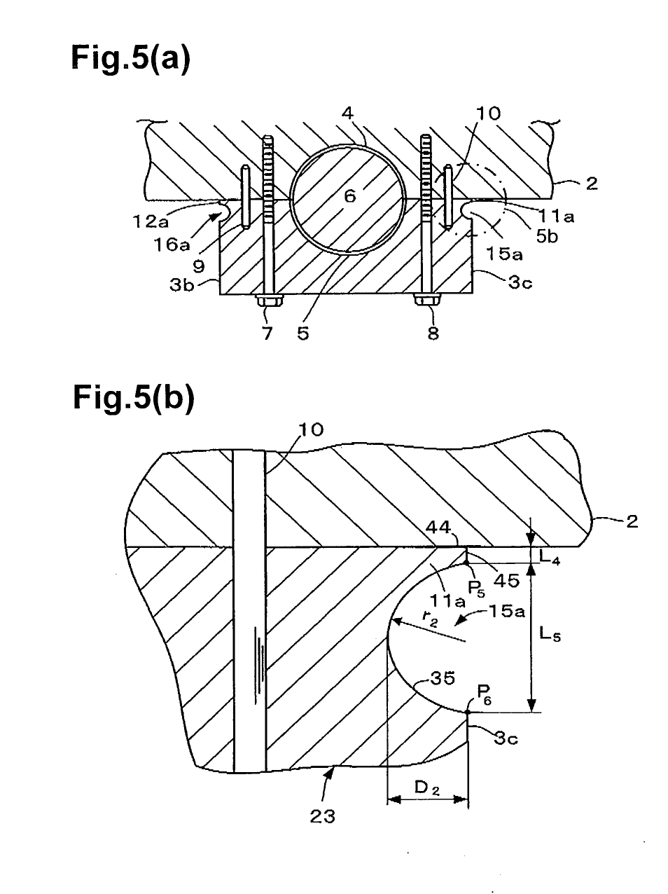

FIGS. 5(a) and 5(b) are diagrams illustrating the bearing structure 1 of the second embodiment of the invention.

A bearing cap 23 of the second embodiment is made of iron material such as cast iron (FC) and is a rectangular block like the bearing cap 3 illustrated in FIG. 2. The recess 3a receiving the lower metal bearing portion 5 is formed in an upper portion of the bearing cap 23. The bearing cap 23 has the bolt through holes 3e, 3f and the pin holes 3g, 3h, which are formed at opposite sides of the recess 3a. The bolt through hole 3e and the bolt through hole 3f are arranged at the positions opposed to the threaded bolt hole 2b and the threaded bolt hole 2c of the lower cylinder block portion 2, respectively. The pin hole 3g and the pin hole 3h are arranged at the positions opposed to the pin hole 2d and the pin hole 2e of the lower cylinder block portion 2, respectively.

As illustrated in FIGS. 5(a) and 5(b), a stress relaxation groove 15a having an opening in the side surface 3c of the bearing cap 23 and extending along the axis of the crankshaft 6 is formed in an upper portion of the side surface 3c. The portion of the bearing cap 3 above the stress relaxation groove 15a forms a projecting end 11a contacting the lower cylinder block portion 2. The projecting end 11a extends in the axial direction of the crankshaft 8. A stress relaxation groove 16a like the stress relaxation groove 15a is formed in an upper portion of the side surface 3b of the bearing cap 23 opposite to the side surface 3c. The portion of the bearing cap 3 above the stress relaxation groove 16a forms a projecting end 12a contacting the lower cylinder block portion 2. The projecting end 12a extends in the axial direction of the crankshaft 6. The stress relaxation groove 16a may be located, shaped, and sized differently from the stress relaxation groove 15a in correspondence with the rotational direction or the shape of the crankshaft 6. The projecting end 12a may be located, shaped, and sized differently from the projecting end 11a in correspondence with the rotational direction or the shape of the crankshaft 6. Further, the stress relaxation groove 16a may be located, shaped, and sized the same as the stress relaxation groove 15a. The projecting end 12a may be located, shaped, and sized the same as the projecting end 11a. A plurality of bearing caps 23 are formed in correspondence with a plurality of shaft portions formed in the crankshaft 6. The stress relaxation grooves 15a, 16a are formed in each of the bearing caps 23. The stress relaxation grooves 15a, 16a may be located, shaped, and sized differently from one bearing cap 23 to another or the same for all of the bearing caps 23. The projecting ends 11a, 12a may be located, shaped, and sized differently from one bearing cap 23 to another or the same for all of the bearing caps 23.

With reference to FIGS. 5(a) and 5(b), a cross section of the stress relaxation groove 15a along a plane perpendicular to the axis of the crankshaft 6 is formed by a curve connecting point P5 and point P6. Point P5 is spaced from the top surface 3d of the bearing cap 23 along the side surface 3c of the bearing cap 23 by a distance L4. Point P6 is spaced downward from point P5 along the side surface 3c by a distance L5. The curve connecting points P5 and P6 has a radius of curvature r2. The distance L4 varies depending on the type of the vehicle, engine performance, the materials of the cylinder block and the bearing cap 23, and other conditions. The distance L4 may be set to any suitable value as long as the distance L4 decreases the rigidity of the projecting end 11a and provides flexibility to the projecting end 11a. The radius of curvature r2 is determined in correspondence with the depth D2.

The stress relaxation groove 15a has a depth D2 with respect to the side surface 3c. Like the distance L4, the depth D2 varies depending on the type of the vehicle, engine performance, the materials of the cylinder block 19 and the bearing cap 23, the distance L4, and other conditions. The depth D2 may be set to any suitable value as long as the depth D2 decreases the rigidity of the projecting end 11a and provides flexibility to the projecting end 11a.

Further, in the second embodiment, the bottom of the stress relaxation groove 15a extends parallel with the axis of the crankshaft 6. The bottom of the stress relaxation groove 15a may be inclined upward or downward with respect to the axis of the crankshaft 6 at a predetermined angle. That is, the bottom of the stress relaxation groove 15a may be inclined with respect to the axis of the crankshaft 6 by, for example, 1 to 10 degrees. Also, although it is preferable that the depth D2 be uniform in the longitudinal direction of the stress relaxation groove 15a, the depth D2 may be varied along the longitudinal direction.

The projecting end 11a extends along the axis of the crankshaft 6. Like the projecting end 11a, the projecting end 12a has a top surface 44 contacting the lower cylinder block portion 2, a side surface 45 having a predetermined length L4 as measured downward from the top surface 44, and a lower surface 35 forming the stress relaxation groove 15a. As has been described, the lower surface 35 is an arcuate surface having the radius of curvature r2. When the inertia force produced through rotation of the crankshaft 6 acts downward with respect to the bearing cap 23, the upper portions of the side surfaces 3b, 3c of the bearing cap 23 press the lower cylinder block portion 2. This deforms the projecting end 11a toward the stress relaxation groove 15a in such a manner as to relax the shearing stress acting on the lower cylinder block portion 2.

As has been described, by forming the stress relaxation grooves 15a, 16a in the upper portions of the side surfaces 3b, 3c of the bearing cap 23, the projecting ends 11a, 12a contacting the lower cylinder block portion 2 are provided in the bearing cap 23. Accordingly, while ensuring a sufficient contact surface area between the lower cylinder block portion 2 and the bearing cap 23, the shearing stress produced in the lower cylinder block portion 2 is reduced. Specifically, the advantages that are the same as those of the bearing structure 1 of the first embodiment are obtained.

A bearing structure 1 according to a third embodiment of the present invention will now be described with reference to the attached drawings mainly on the differences between the first embodiment and the third embodiment.

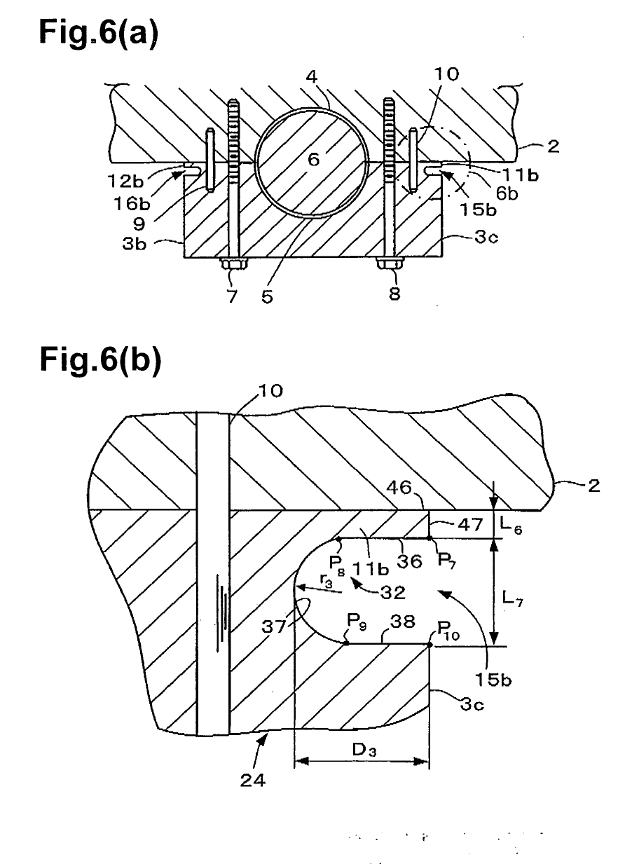

FIGS. 6(a) and 6(b) are diagrams illustrating the bearing structure 1 of the third embodiment of the invention.

A bearing cap 24 of the third embodiment is made of iron material such as cast iron (FC) and is a rectangular block like the bearing cap 3 illustrated in FIG. 2. The recess 3a receiving the lower metal bearing portion 5 is formed in an upper portion of the bearing cap 24. The bearing cap 24 has the bolt through holes 3e, 3f and the pin holes 3h, 3i, which are formed at opposite sides of the recess 3a. The bolt through hole 3e and the bolt through hole 3f are arranged at the positions opposed to the threaded bolt hole 2b and the threaded bolt hole 2c of the lower cylinder block portion 2, respectively. The pin hole 3h and the pin hole 3i are arranged at the positions opposed to the pin hole 2d and the pin hole 2e of the lower cylinder block portion 2, respectively.

As illustrated in FIGS. 6(a) and 6(b), a stress relaxation groove 15b having an opening in the side surface 3c of the bearing cap 24 and extending along the axis of the crankshaft 6 is formed in an upper portion of the side surface 3c. The portion of the bearing cap 24 above the stress relaxation groove 15b forms a projecting end 11b contacting the lower cylinder block portion 2. The projecting end 11b extends in the axial direction of the crankshaft 8. A stress relaxation groove 16b like the stress relaxation groove 15b is formed in an upper portion of the side surface 3b of the bearing cap 24 opposite to the side surface 3c. The portion of the bearing cap 24 above the stress relaxation groove 16b forms a projecting end 12b contacting the lower cylinder block portion 2. The projecting end 12b extends in the axial direction of the crankshaft 6. The stress relaxation groove 16b may be located, shaped, and sized differently from the stress relaxation groove 15b in correspondence with the rotational direction or the shape of the crankshaft 6. The projecting end 12b may be located, shaped, and sized differently from the projecting end 11b in correspondence with the rotational direction or the shape of the crankshaft 6. Further, the stress relaxation groove 16b may be located, shaped, and sized the same as the stress relaxation groove 15b. The projecting end 12b may be located, shaped, and sized the same as the projecting end 11b. A plurality of bearing caps 24 are formed in correspondence with a plurality of shaft portions formed in the crankshaft 6. The stress relaxation grooves 15b, 16b are formed in each of the bearing caps 24. The stress relaxation grooves 15b, 16b may be located, shaped, and sized differently from one bearing cap 24 to another. The projecting ends 11b, 12b may be located, shaped, and sized differently from one bearing cap 24 to another or the same for all of the bearing caps 24.

With reference to FIGS. 6(a) and 6(b), a cross section of the stress relaxation groove 15b along a plane perpendicular to the axis of the crankshaft 6 is formed by a line connecting point P7 and point P8, a line connecting point P10 and point P9, and a curve connecting point P8 and point P9. Point P7 is spaced from the top surface 3d of the bearing cap 24 along the side surface 3c of the bearing cap 24 by a distance L6. Point P8 is spaced from point P7 in the inward direction of the stress relaxation groove 15b. Point P10 is spaced downward from point P7 along the side surface 3c by a distance L7. The line connecting point P7 and point P8 is parallel with the top surface 3d of the bearing cap 24. The curve connecting points P8 and P9 has a radius of curvature r3.

The distance L6 varies depending on the type of the vehicle, engine performance, the materials of the cylinder block 19 and the bearing cap 24, and other conditions. The distance L6 may be set to any suitable value as long as the distance L6 decreases the rigidity of the projecting end 11b and provides flexibility to the projecting end 11b. Like the distance L6, the radius of curvature r3 varies depending on the type of the vehicle, engine performance, the materials of the cylinder block 19 and the bearing cap 24, and other conditions. The radius of curvature r3 may be set to any suitable value as long as the radius of curvature r3 decreases the rigidity of the projecting end 11b and provides flexibility to the projecting end 11b.

The stress relaxation groove 15b has a depth D3 with respect to the side surface 3c. Like the distance L6, the depth D3 varies depending on the type of the vehicle, engine performance, the materials of the cylinder block 19 and the bearing cap 24, the distance L6, and other conditions. The depth D3 may be set to any suitable value as long as the depth D3 decreases the rigidity of the projecting end 11b and provides flexibility to the projecting end 11b.

Further, in the third embodiment, the bottom of the stress relaxation groove 15b extends parallel with the axis of the crankshaft 6. The bottom of the stress relaxation groove 15b may be inclined upward or downward with respect to the axis of the crankshaft 6 at a predetermined angle. Also, although it is preferable that the depth D3 be uniform in the longitudinal direction of the stress relaxation groove 15b, the depth D3 may be varied along the longitudinal direction.

The projecting end 11b extends in the axial direction of the crankshaft 6. As illustrated in FIG. 6(b), the projecting end 11b has a top surface 46 contacting the lower cylinder block portion 2, a side surface 47 having a predetermined length L4 as measured downward from the top surface 46, and a lower surface 32 forming the stress relaxation groove 15b. The lower surface 32 has a parallel surface 36 and an arcuate surface 37 having the radius of curvature r2. When the inertia force produced through rotation of the crankshaft 6 acts downward with respect to the bearing cap 24, the upper portions of the side surfaces 3b, 3c of the bearing cap 24 press the lower cylinder block portion 2. This deforms the projecting end 11b toward the stress relaxation groove 15b in such a manner as to relax the shearing stress acting on the lower cylinder block portion 2.

As has been described, by forming the stress relaxation grooves 15b, 16b in the upper portions of the side surfaces 3b, 3c of the bearing cap 24, the projecting ends 11b, 12b contacting the lower cylinder block portion 2 are provided in the bearing cap 24. Accordingly, while ensuring a sufficient contact surface area between the lower cylinder block portion 2 and the bearing cap 24, the shearing stress produced in the lower cylinder block portion 2 is reduced. Specifically, the advantages that are the same as those of the bearing structure 1 of the first embodiment are obtained.

A bearing structure 1 according to a fourth embodiment of the present invention will now be described with reference to the attached drawings mainly on the differences between the first embodiment and the fourth embodiment.

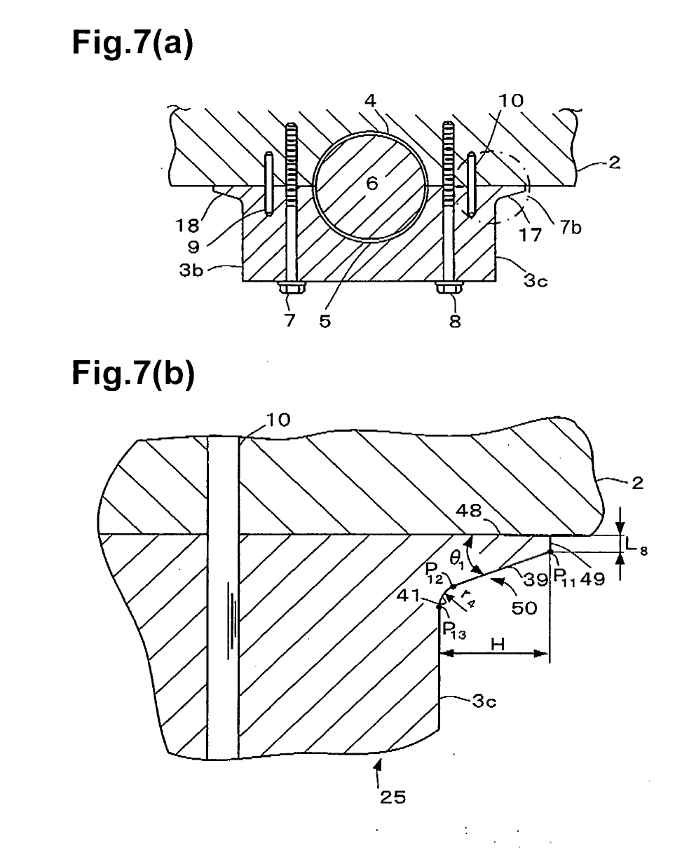

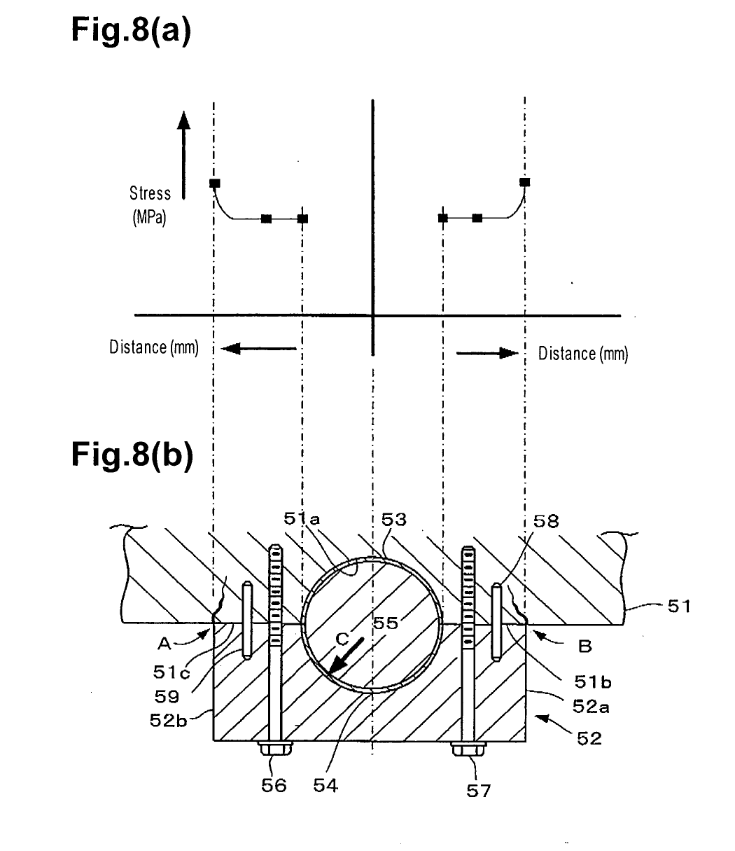

FIGS. 7(a) and 7(b) are diagrams illustrating the bearing structure 1 of the fourth embodiment of the invention.

A bearing cap 25 of the fourth embodiment is made of iron material such as cast iron (FC) and is a rectangular block like the bearing cap 3 illustrated in FIG. 2. The recess 3a receiving the lower metal bearing portion 5 is formed in an upper portion of the bearing cap 25. The bearing cap 25 has the bolt through holes 3e, 3f and the pin holes 3g, 3h, which are formed at opposite sides of the recess 3a. The bolt through hole 3e and the bolt through hole 3f are arranged at the positions opposed to the threaded bolt hole 2b and the threaded bolt hole 2c of the lower cylinder block portion 2, respectively. The pin hole 3g and the pin hole 3h are arranged at the positions opposed to the pin hole 2d and the pin hole 2e of the lower cylinder block portion 2, respectively.

As illustrated in FIGS. 7(a) and 7(b), a projection 17 extending along the axis of the crankshaft 6 is formed in an upper portion of the side surface 3c of the bearing cap 25. A projection 18 like the projection 17 is formed in an upper portion of the side surface 3b of the bearing cap 25 opposite to the side surface 3c. The projection 18 may be located, shaped, and sized differently from the projection 17 in correspondence with the rotational direction or the shape of the crankshaft 6. Alternatively, the projection 17 may be located, shaped, and sized the same as the projection 18. A plurality of bearing caps 25 are formed in correspondence with a plurality of shaft portions formed in the crankshaft 6. The projections 17, 18 are formed in each of the bearing caps 25. The projections 17, 18 may be located, shaped, and sized differently from one bearing cap 25 to another or the same for all of the bearing caps 25.

The projection 17 extends in the axial direction of the crankshaft 6. As illustrated in FIGS. 7(a) and 7(b), the projection 17 has a top surface 48 contacting the lower cylinder block portion 2, a side surface 49 extending downward from the top surface 48, and a lower surface 50 having an inclined surface 39, which is inclined with respect to the side surface 49 at a predetermined angle, and an arcuate surface 41. A cross section of the projection 17 along a plane perpendicular to the axis of the crankshaft 6 is formed by a line connecting point P11 and point P12 and a curve connecting point P13 and point P12. Point P11 is spaced from the top surface 48 of the bearing cap 25 along the side surface 49 of the bearing cap 25 by a distance L8. Point P12 is spaced from point P11 in an inward direction. Point P13 is arranged on the side surface 3c and spaced downward from point P12. The line connecting point P11 and point P12 is inclined with respect to the top surface 48 at the angle θ1. The curve connecting point P13 and point P12 has a radius of curvature r4.

The distance L8 varies depending on the type of the vehicle, engine performance, the materials of the cylinder block 19 and the bearing cap 25, and other conditions. The distance L8 may be set to any suitable value as long as the distance L8 decreases the rigidity of the projection 17 and provides flexibility to the projection 17. The angle θ1 varies depending on the type of the vehicle, engine performance, the materials of the cylinder block 19 and the bearing cap 25, and other conditions. The angle θ1 may be set to any suitable value as long as the angle θ decreases the rigidity of the projection 17 and provides flexibility to the projection 17. Like the distance L6, the radius of curvature r4 varies depending on the type of the vehicle, engine performance, the materials of the cylinder block 19 and the bearing cap 25, and other conditions. The radius of curvature r4 may be set to any suitable value as long as the radius of curvature r4 decreases the rigidity of the projection 17 and provides flexibility to the projection 17.

Like the distance L6, the height H of the distal surface 49 of the projection 17 with respect to the side surface 3c varies depending on the type of the vehicle, engine performance, the materials of the cylinder block 19 and the bearing cap 25, the distance L6, and other conditions. The height H may be set to any suitable value as long as the height H decreases the rigidity of the projection 17 and provides flexibility to the projection 17. Further, in the fourth embodiment, the distal surface 49 of the projection 17 and the axis of the crankshaft 6 are parallel with each other. The distal surface 49 of the projection 17 may be inclined with respect to the axis of the crankshaft 6 at a predetermined angle. Also, although it is preferable that the height H be uniform in the longitudinal direction of the projection 17, the height H may be varied along the longitudinal direction.

As has been described, by forming the projections 17, 18 in the upper portions of the side surfaces 3b, 3c of the bearing cap 25, the shearing stress produced in the lower cylinder block portion 2 is reduced while a sufficient contact surface area is ensured between the lower cylinder block portion 2 and the bearing cap 25. Specifically, the advantages that are the same as those of the bearing structure 1 of the first embodiment are obtained.

As has been explained, in the bearing structure 1 according to the present invention, the stress relaxation grooves 15, 16, each of which has an opening in the corresponding one of the side surfaces 3b, 3c of the bearing cap 3 and extends along the axis of the crankshaft 6, are formed in the upper portions of the side surfaces 3b, 3c. Accordingly, when the external force produced through rotation of the crankshaft 6 acts downward with respect to the bearing cap 3, the upper portions of the side surfaces 3b, 3c of the bearing cap 3 press the lower cylinder block portion 2, thus reducing the stress produced in the lower cylinder block portion 2. As a result, while ensuring a sufficient contact area between the cylinder block and the bearing cap, the shearing force produced in the cylinder block is decreased. This effectively improves durability and prevents cracks caused by fretting fatigue. Also, the crankshaft bearing structure of the present invention is useful generally in bearing structures in which a bearing of a rotary shaft is held by an independently structured bearing cap.

1. A bearing structure for a crankshaft, the crankshaft being rotatably held by a lower cylinder block portion and a bearing cap arranged below the lower cylinder block portion,
wherein stress relaxation grooves extending along the axis of the crankshaft are formed in upper portions of opposite sides of the bearing cap, the stress relaxation grooves having openings in opposite side surfaces of the bearing cap, and
wherein, by forming the stress relaxation grooves, projecting ends extending along the axis of the crankshaft are formed in the upper portions at the opposite sides of the bearing cap, the projecting ends being flexible in response to a load acting on the bearing cap when the crankshaft rotates.

2. The bearing structure according to claim 1,
wherein each of the projecting ends has a top surface contacting the lower cylinder block portion, a side surface having a predetermined length as measured downward from the top surface, and a lower surface forming at least a portion of the corresponding one of the stress relaxation grooves, and
wherein the lower surface has an inclined surface inclined with respect to the top surface and an arcuate surface formed continuously from the inclined surface.

3. The bearing structure according to claim 1,
wherein each projecting end has a top surface contacting the lower cylinder block portion, a side surface having a predetermined length as measured downward from the top surface, and a lower surface forming the corresponding stress relaxation groove, and
wherein the lower surface has a parallel surface parallel with the top surface and an arcuate surface formed continuously from the parallel surface.

4. The bearing structure according to claim 1,
wherein each projecting end has a top surface contacting the lower cylinder block portion, a side surface having a predetermined length as measured downward from the top surface, and a lower surface forming at least a portion of the corresponding stress relaxation groove, and
wherein the lower surface is an arcuate surface.

5. The bearing structure according to claim 1,
wherein each projecting end has a top surface contacting the lower cylinder block portion, a side surface formed continuously from the top surface, and a lower surface forming at least a portion of the corresponding stress relaxation groove, and
wherein the lower surface has a surface that is formed continuously from the side surface and inclined with respect to or parallel with the top surface.

6. The bearing structure according to claim 5, wherein the lower surface includes an inclined surface formed continuously from the side surface, the inclined surface being inclined with respect to the top surface in such a manner that the thickness of the associated projecting end becomes greater from the distal end toward the proximal end of the projecting end.

7. A bearing structure for a crankshaft, the crankshaft being rotatably held by a lower cylinder block portion and a bearing cap arranged below the lower cylinder block portion,
wherein projections extending along the axis of the crankshaft are formed in upper portions of opposite sides of the bearing cap, the projections projecting from opposite side surfaces of the bearing cap in directions away from the crankshaft and having a top surface contacting the lower cylinder block portion.

8. The bearing structure according to claim 7,
wherein each of the projections has a top surface contacting the lower cylinder block portion and a distal surface having a predetermined length as measured downward from the top surface, and
wherein the lower surface has an inclined surface inclined with respect to the top surface and an arcuate surface formed continuously from the inclined surface.
